(19) United States
(12) Patent Application Publication
(10) Pub. No.: US 2015/0207142 A1
(43) Pub. Date: Jul. 23, 2015

(54) NONAQUEOUS ELECTROLYTE SECONDARY BATTERY

(71) Applicant: SANYO Electric Co., Ltd., Moriguchi-shi, Osaka (JP)

(72) Inventors: Manabu Takijiri, Osaka (JP); Junichi Sugaya, Osaka (JP); Masanobu Takeuchi, Hyogo (JP); Katsunori Yanagida, Hyogo (JP); Takeshi Ogasawara, Hyogo (JP)

(73) Assignee: SANYO Electric Co., Ltd., Moriguchi-shi, Osaka (JP)

(21) Appl. No.: 14/417,969

(22) PCT Filed: Aug. 20, 2013
(86) PCT No.: PCT/JP2013/004913

§ 371 Date: Jan. 28, 2015

(30) Foreign Application Priority Data
Aug. 27, 2012 (JP) 2012-186809
Mar. 29, 2013 (JP) 2013-073418

(51) Int. Cl. H01M 4/36; H01M 10/052; H01M 4/485; H01M 10/0567

(52) U.S. Cl. CPC H01M 4/366; H01M 10/0567; H01M 10/052; H01M 4/485

(57) ABSTRACT

A nonaqueous electrolyte secondary battery according to an embodiment of the present invention includes a positive electrode (1) containing a positive electrode active material that contains a lithium transition metal oxide having a surface to which a compound of a rare-earth element is adhered, a negative electrode (2) containing a negative electrode active material, and a nonaqueous electrolyte to which a lithium salt having a P—O bond and a P—F bond in its molecule and/or a lithium salt having a B—O bond and a B—F bond in its molecule is added.

### TECHNICAL FIELD

The present invention relates to a nonaqueous electrolyte secondary battery.

### BACKGROUND ART

In recent years, reductions in the size and weight of mobile information terminals, such as cellular phones, notebook personal computers, and smartphones, have proceeded rapidly. Batteries used as driving power sources are required to have higher capacity. Nonaqueous electrolyte secondary batteries, which are charged and discharged by the transfer of lithium ions between positive and negative electrodes when charge and discharge are performed, have high energy densities and high capacities; hence, nonaqueous electrolyte secondary batteries are widely used as driving power sources for such mobile information terminals.

In addition, nonaqueous electrolyte secondary batteries have recently been receiving attention as power sources to drive electric power tools and electric vehicles and thus are expected to be used in diverse applications. Such driving power sources are required to have higher capacities for prolonged use and improved cycle characteristics when large-current discharge is repeated in a relatively short time. In applications, such as electric power tools and electric vehicles, it is particularly essential to achieve higher capacities while cycle characteristics at large-current discharge are maintained.

As a method for achieving a battery having a higher capacity, a method is known in which an available voltage range is extended by increasing a charging voltage. When the charging voltage is increased, however, the oxidizing power of a positive electrode active material is increased. Furthermore, the positive electrode active material contains a transition metal (for example, Co, Mn, Ni, or Fe) having catalytic properties, thus causing, for example, the decomposition reaction of a nonaqueous electrolytic solution. This raises a problem in which a coating film that inhibits the large-current discharge is formed on a surface of the positive electrode active material. The following reports are made.

(1) A report that an increase in floating current during charging at a high temperature is inhibited by allowing an oxide of Gd or the like to be present on surfaces of particles of a base material capable of intercalating and deintercalating lithium ions (see PTL 1).
(2) A report that rate characteristics after high-temperature storage are improved by allowing a nonaqueous electrolytic solution to contain a cyclic disulfonate ester and at least one lithium salt selected from the group consisting of lithium difluorophosphate, lithium bis(fluorosulfonyl)amide, and lithium fluorosulfonate (see PTL 2).

### CITATION LIST

### Patent Literature

PTL 1: International Publication No. WO2005/008812

PTL 2: Japanese Published Unexamined Patent Application No. 2012-94454

### SUMMARY OF INVENTION

### Technical Problem

In the reports described in items (1) and (2), however, there is a problem in which the cycle characteristics at large-current discharge are not improved.

### Solution to Problem

A nonaqueous electrolyte secondary battery according to an embodiment of the present invention includes a positive electrode containing a positive electrode active material that contains a lithium transition metal oxide having a surface to which a compound of a rare-earth element is adhered; a negative electrode containing a negative electrode active material; and a nonaqueous electrolyte to which a lithium salt having a P—O bond and a P—F bond in its molecule and/or a lithium salt having a B—O bond and a B—F bond in its molecule is added.

### Advantageous Effects of Invention

The structure of a battery according to an embodiment of the present invention has an excellent effect of markedly improving the cycle characteristics at large-current discharge.

### BRIEF DESCRIPTION OF DRAWINGS

FIG. 1 is a schematic, longitudinal sectional view illustrating a schematic structure of a cylindrical nonaqueous electrolyte secondary battery according to an embodiment of the present invention.

FIG. 2 is a schematic view illustrating a schematic structure of a three-electrode test cell according to an embodiment of the present invention.

### DESCRIPTION OF EMBODIMENTS

A nonaqueous electrolyte secondary battery according to an embodiment of the present invention includes a positive electrode containing a positive electrode active material that contains a lithium transition metal oxide having a surface to which a compound of a rare-earth element is adhered, a negative electrode containing a negative electrode active material, and a nonaqueous electrolyte to which a lithium salt having a P—O bond and a P—F bond in its molecule and/or a lithium salt having a B—O bond and a B—F bond in its molecule is added.

In the foregoing structure, the compound of the rare-earth element adhered to the surface of the lithium transition metal oxide reacts with the lithium salt having a P—O bond and a P—F bond in its molecule and/or with the lithium salt having a B—O bond and a B—F bond in its molecule (in order to distinguish from a lithium salt serving as a solute described below, the lithium salt is also referred to as a “lithium salt serving as an additive”, in some cases) at the time of charging to form a good-quality film having both lithium-ion permeability and electrical conductivity on the surface of the lithium transition metal oxide. This allows the insertion-extraction reaction of lithium ions to proceed smoothly while inhibiting the decomposition reaction of the nonaqueous electrolytic solution during charging and discharging is inhibited, thus improving the cycle characteristics at large-current discharge. Thus, an embodiment of the present invention is significantly useful for applications, such as tools including batteries that are required to discharge at large currents of, for example, 10 A or 20 A. In an embodiment of the present invention, the same effect is provided even when discharge is performed at a current of 2 It or more. The good-quality film is often principally formed at the initial charging and seems to be also formed at the second and subsequent charges.

Although a detailed reaction mechanism for the formation of the good-quality film by the reaction between the lithium salt serving as an additive and the compound of the rare-earth element on the surface of the lithium transition metal oxide at the time of charging is unclear, it is speculated as follows: In the case where the compound of the rare-earth element is adhered to the surface of the lithium transition metal oxide, the lithium salt serving as an additive is selectively drawn to the positive electrode side at the time of charging, because a P—O bonding and a P—F bonding and/or a B—O bonding and a B—F bonding are present in the molecule of the lithium salt serving as an additive. With a charging reaction, the rare-earth element reacts with the lithium salt serving as an additive to form the good-quality film on the surface of the lithium transition metal oxide.

Although the reason the lithium salt serving as an additive reacts selectively with the rare-earth element on the surface of the lithium transition metal oxide at the time of charging is unclear, it is speculated as follows: The rare-earth element has an electron in the 4f orbital. Thus, the P—O bond and the P—F bond and/or the B—O bond and the B—F bond of the lithium salt serving as an additive are easily drawn at the time of charging, thereby leading to the selective reaction.

Each of the P—O bond and the B—O bond of the lithium salt serving as an additive may be a saturated bond or an unsaturated bond. Examples of the lithium salt serving as an additive include lithium monofluorophosphate (Li₂PC₃F), lithium difluoroborate (LiBF₂O), lithium difluoro(oxalato)borate (Li[B(C₂O₄)F₂]), lithium tetrafluoro(oxalato)phosphate (Li[P(C₂O₄)F₄]), and lithium difluoro(oxalato)phosphate (Li[P(C₂O₄)₂F₂]) in addition to lithium difluorophosphate (LiPO₂F₂).

The foregoing compound of the rare-earth element is preferably a hydroxide of the rare-earth element, an oxyhydroxide of the rare-earth element, or an oxide of the rare-earth element. In particular, the hydroxide of the rare-earth element or the oxyhydroxide of the rare-earth element is preferred. The reason for this is that the use of the compound more successfully provides the foregoing advantageous effects. In addition to the compound, the compound of the rare-earth element may partially contain a carbonate compound of the rare-earth element, a phosphate compound of the rare-earth element, or the like.

Examples of the rare-earth element contained in the compound of the rare-earth element include yttrium, lanthanum, cerium, neodymium, samarium, europium, gadolium, cerium, terbium, dysprosium, holmium, erbium, thulium, ytterbium, and lutetium. Of these, neodymium, samarium, and erbium are preferred. Neodymium compounds, samarium compounds, and erbium compounds have small average particle diameters, compared with other compounds of rare-earth elements, and thus are easily precipitated more uniformly on the surface of the positive electrode active material.

Specific examples of the compound of the rare-earth element include neodymium hydroxide, neodymium oxyhydroxide, samarium hydroxide, samarium oxyhydroxide, erbium hydroxide, and erbium oxyhydroxide. In the case where lanthanum hydroxide or lanthanum oxyhydroxide is used as the compound of the rare-earth element, it is possible to reduce the production cost of the positive electrode because lanthanum is inexpensive.

The compound of the rare-earth element preferably has an average particle diameter of 1 nm or more and 100 nm or less. When the compound of the rare-earth element has an average particle diameter more than 100 nm, the particle diameters of the compound of the rare-earth element are excessively large with respect to the diameters of particles of the lithium transition metal oxide. Thus, the surfaces of particles of the lithium transition metal oxide are not densely covered with the compound of the rare-earth element. This results in an increase in the area of the lithium transition metal oxide particles in direct contact with the nonaqueous electrolyte and its reductive decomposition product. Thus, the oxidation decomposition of the nonaqueous electrolyte and its reductive decomposition product proceeds, thereby reducing the charge-discharge characteristics.

When the compound of the rare-earth element has an average particle diameter less than 1 nm, the surfaces of the lithium transition metal oxide particles are excessively densely covered with the compound of the rare-earth element. This reduces the intercalation-deintercalation performance of lithium ions on the surface of the lithium transition metal oxide particles, thereby reducing the charge-discharge characteristics. In light of these facts, the compound of the rare-earth element preferably has an average particle diameter of 10 nm or more and 50 nm or less.

The compound of the rare-earth element, such as erbium oxyhydroxide, is adhered to the lithium transition metal oxide by mixing a solution containing the lithium transition metal oxide dispersed therein with, for example, an aqueous solution of an erbium salt dissolved therein. There is an alternative method in which the lithium transition metal oxide is sprayed with an aqueous solution of an erbium salt dissolved therein under stirring and then dried. In particular, the method in which the solution containing the lithium transition metal oxide dispersed therein is mixed with the aqueous solution of a rare-earth salt, such as an erbium salt, dissolved therein is preferably used. The reason for this is that the compound of the rare-earth element can be adhered to the surface of the lithium transition metal oxide by the method while being more uniformly dispersed. In this case, it is preferred that the pH of the solution containing the lithium transition metal oxide dispersed therein be constant. In particular, to precipitate 1- to 100-nm-size fine particles in a uniformly dispersed state on the surface of the lithium transition metal oxide, the pH is preferably regulated to 6 to 10. A pH less than 6 may cause the elution of the transition metal of the lithium transition metal oxide. A pH more than 10 may cause the segregation of the compound of the rare-earth element.

The proportion of the rare-earth element is preferably 0.003% by mole or more and 0.25% by mole or less with respect to the total molar amount of the transition metal in the lithium transition metal oxide. If the proportion is less than 0.003% by mole, the effect resulting from the adherence of the compound of the rare-earth element is not sufficiently provided, in some cases. If the proportion is more than 0.25% by mole, the lithium-ion permeability may be reduced on the surfaces of the lithium transition metal oxide particles to reduce the cycle characteristics.

Examples of the lithium salt serving as an additive include lithium salts represented by the composition formula LiₓM_{y}O_{z}F_{α}C_{β} (wherein M represents B or P, x represents an integer of 1 to 4, y represents 1 or 2, z represents an integer of 1 to 8, α represents an integer of 1 to 4, and β represents an integer of 0 to 4). Examples of a carbon-free lithium salt (β=0) include lithium difluorophosphate (LiPO₂F₂), lithium monofluorophosphate (Li₂PO₃F), and lithium difluoroborate (LiBF₂O). Examples of a carbon-containing lithium salt (β represents an integer of 1 to 3) include lithium difluoro(oxalato)borate (Li[B(C₂O₄)F₂]: LiFOB), lithium tetrafluoro(oxalato)phosphate (Li[P(C₂O₄)F₄]), and lithium difluoro(oxalato)phosphate (Li[P(C₂O₄)₂F₂]).

The proportion of the lithium salt serving as an additive is preferably 0.01% by mole or more and 5% by mole or less, more preferably 0.03% by mole or more and 2% by mole or less, and particularly preferably 0.03% by mole or more and 0.15% by mole or less with respect to the total molar amount of the nonaqueous electrolyte.

At an excessively small amount of the lithium salt serving as an additive, the lithium salt cannot react sufficiently with the compound of the rare-earth element. It is thus difficult to sufficiently form a good-quality film. At an excessively large amount of the lithium salt serving as an additive, the resulting film has a large thickness, thus inhibiting the insertion-extraction reaction of lithium and reducing the cycle characteristics at large-current discharge.

Preferably, the lithium transition metal oxide has a layered structure represented by the general formula LiMeO₂ (wherein Me represents at least one selected from the group consisting of Ni, Co, Mn, and Al).

However, the lithium transition metal oxide is not limited to thereto. The lithium transition metal oxide may be, for example, a lithium transition metal oxide having an olivine structure represented by the general formula LiMePO₄ (wherein Me represents at least one selected from the group consisting of Fe, Ni, Co, and Mn) or a lithium transition metal oxide having a spinel structure represented by the general formula LiMe₂O₄ (wherein Me represents at least one selected from the group consisting of Fe, Ni, Co, and Mn). The lithium transition metal oxide may further contain at least one selected from the group consisting of magnesium, aluminum, titanium, chromium, vanadium, iron, copper, zinc, niobium, molybdenum, zirconium, tin, tungsten, sodium, and potassium. Of these, aluminum is preferably contained. Specific examples of the lithium transition metal oxide preferably used include LiCoO₂, LiNiO₂, LiNi_{1/3}Co_{1/3}Mn_{1/3}O₂, LiFePO₄, LiMn₂O₄, and LiNi_{0.8}Co_{0.15}Al_{0.05}O₂. More preferably, lithium nickel cobalt manganese oxide and lithium nickel cobalt aluminum oxide are exemplified.

### (Other Matters)

(1) A solvent for the nonaqueous electrolyte is not particularly limited. Solvents that have been used for nonaqueous electrolyte secondary batteries may be used. Examples of the solvents that may be used include cyclic carbonates, such as ethylene carbonate, propylene carbonate, butylene carbonate, and vinylene carbonate; linear carbonates, such as dimethyl carbonate, methyl ethyl carbonate, and diethyl carbonate; ester-containing compounds, such as methyl acetate, ethyl acetate, propyl acetate, methyl propionate, ethyl propionate, and γ-butyrolactone; sulfone group-containing compounds, such as propanesultone; ether-containing compounds, such as 1,2-dimethoxyethane, 1,2-diethoxyethane, tetrahydrofuran, 1,2-dioxane, 1,4-dioxane, and 2-methyltetrahydrofuran; nitrile-containing compounds, such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide-containing compounds, such as dimethylformamide. In particular, solvents in which H atoms of these solvents are partially substituted with F atoms are preferably used. These solvents may be used separately or in combination of two or more. In particular, solvents containing combinations of cyclic carbonates and linear carbonates, and solvents containing cyclic carbonates and linear carbonates in combination with small amounts of nitrile-containing compounds and ether-containing compounds are preferred.

As a nonaqueous solvent for the nonaqueous electrolyte, an ionic liquid may also be used. In this case, cationic species and anionic species are not particularly limited. In particular, combinations of a pyridinium cation, an imidazolium cation, and a quaternary ammonium cation, which serve as cations, and a fluorine-containing imide-based anion, which serves as an anion are preferably used from the viewpoints of low viscosity, electrochemical stability, and hydrophobicity.

As a solute used for the nonaqueous electrolyte, known lithium salts that have been used for nonaqueous electrolyte secondary batteries may be used. As such lithium salts, lithium salts each containing one or more elements selected from P, B, F, O, S, N, and Cl may be used. Specifically, lithium salts, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₅SO₂) LiC(C₂F₅SO₂)₃, LiAsF₆, and LiClO₄, and mixtures thereof may be used. In particular, to improve the high-rate charge-discharge characteristics and durability, LiPF₆ is preferably used.

As the solute, a lithium salt containing an oxalato complex serving as an anion may also be used. As the lithium salt containing an oxalato complex serving as an anion, a lithium salt containing an anion in which a central atom is coordinated with C₂O₄²⁻, such as Li[M(C₂O₄)ₓR_{y}] (wherein in the formula, M represents an element selected from transition metals and elements in groups IIIb, IVb, and Vb of the periodic table, R represents a group selected from halogens, alkyl groups, and halogen-substituted alkyl groups, x represents a positive integer, and y represents zero or a positive integer) may be used in addition to lithium bis(oxalato)borate (Li[B(C₂O₄)₂]: LiBOB). A specific example thereof is Li[P(C₂O₄)₃]. To form a stable film on the surface of the negative electrode in a high-temperature environment, LiBOB is most preferably used. The foregoing solutes may be used separately or in combination as a mixture. The concentration of the solute is not particularly limited. The concentration of the solute is preferably 0.8 to 1.7 mol in 1 L of the nonaqueous electrolyte. For applications that require large-current discharge, the concentration of the solute is preferably 1.0 to 1.6 mol in 1 L of the nonaqueous electrolyte.

(2) The negative electrode active material is not particularly limited as long as it can reversibly intercalate and deintercalate lithium. Examples of the material that may be used include carbon materials, metals and alloying materials which can be alloyed with lithium, and metal oxides. Such a carbon material is preferably used for the negative electrode active material from the viewpoint of material cost. Examples of the carbon material that may be used include natural graphite, artificial graphite, mesophase pitch-based carbon fibers (MCFs), mesocarbon microbeads (MCMBs), coke, and hard carbon. In particular, a graphite material covered with low-crystallinity carbon is preferably used as the negative electrode active material from the viewpoint of improving the high-rate charge-discharge characteristics.
(3) As a separator, separators that have been used may be used. Specifically, a separator composed of polyethylene, a separator in which a layer composed of polypropylene is provided on a surface of polyethylene, and a polyethylene separator having a surface coated with, for example, an alamid-based resin may be used.
(4) An inorganic filler-containing layer that has been used may be provided at the interface between the positive electrode and the separator or the interface between the negative electrode and the separator. As the filler, oxides and phosphate compounds of one or more of titanium, aluminum, silicon, magnesium, and so forth, which have been used, may be used. These oxides and phosphate compounds may have surfaces treated with, for example, hydroxides. The filler layer may be formed by, for example, a method in which a slurry containing the filler is directly applied to the positive electrode, the negative electrode, or the separator or a method in which a sheet composed of the filler is bonded to the positive electrode, the negative electrode, or the separator.

### Examples

While embodiments of the present invention will be described in more detail below by specific examples, the embodiments of the present invention are not limited to these examples. Appropriate changes may be made without departing from the gist of the invention.

### First Example

### Example

### Synthesis of Positive Electrode Active Material

To 3 L of deionized water, 1000 g of particles of lithium nickel cobalt manganese oxide represented by LiNi_{0.55}Co_{0.20}Mn_{0.25}O₂ was added. The mixture was stirred. A solution of 4.58 g of erbium nitrate pentahydrate dissolved was added to the mixture. At this time, an aqueous solution containing 10% by mass sodium hydroxide was appropriately added so as to adjust the pH of the solution containing lithium nickel cobalt manganese oxide to 9. After suction filtration and washing with water were performed, heat treatment was performed at 400° C. for 5 hours in an air atmosphere, thereby preparing lithium nickel cobalt manganese oxide having a surface to which erbium oxyhydroxide was uniformly adhered. The amount of erbium oxyhydroxide adhered was, in terms of elemental erbium, 0.1% by mole with respect to the total molar amount of the transition metals in lithium nickel cobalt manganese oxide.

[Production of Positive Electrode]

With 100 parts by mass of the positive electrode active material, 4 parts by mass of carbon black serving as a carbon conductive agent and 2 parts by mass of polyvinylidene fluoride serving as a binder were mixed. An appropriate amount of N-methyl-2-pyrrolidone (NMP) was added thereto, thereby preparing a positive-electrode slurry. The positive-electrode slurry was applied to both surfaces of a positive-electrode collector composed of aluminum, dried, and cut to give a piece with a predetermined electrode size. The piece was rolled with rollers and fitted with a positive-electrode lead to provide a positive electrode.

### [Production of Negative Electrode]

First, 97.5 parts by mass of artificial graphite serving as a negative electrode active material, 1 part by mass of carboxymethylcellulose serving as a thickener, and 1.5 parts by mass of styrene-butadiene rubber serving as a binder were mixed together. An appropriate amount of deionized water was added thereto, thereby preparing a negative-electrode slurry. The negative-electrode slurry was applied to both surfaces of a negative-electrode collector formed of copper foil, dried, and cut to give a piece with a predetermined electrode size. The piece was rolled with rollers and fitted with a negative-electrode lead to provide a negative electrode.

### [Preparation of Nonaqueous Electrolyte]

LiPF₆ serving as a solute was dissolved in a solvent mixture in a proportion of 1.5 mol/L, the solvent mixture containing ethylene carbonate (EC), methyl ethyl carbonate (MEC), dimethyl carbonate (DMC), propylene carbonate (PC), and fluoroethylene carbonate (FEC) mixed in a volume ratio of 10:10:65:5:10. Then lithium difluorophosphate (LiPO₂F₂) was added thereto in a proportion of 0.46% by mole with respect to the total molar amount of the nonaqueous electrolyte, thereby preparing a nonaqueous electrolytic solution.

### [Production of Battery]

The positive electrode and the negative electrode were arranged so as to face each other with a separator formed of a microporous polyethylene film provided therebetween. The resulting article was spirally wound with a winding core. The winding core was pulled out to provide a spirally electrode assembly. The electrode assembly was inserted into a metal jacket. The nonaqueous electrolytic solution was injected thereinto. The metal jacket was sealed to produce a 18650-type nonaqueous electrolyte secondary battery (capacity: 2.0 Ah) having a diameter of 18 mm and a height of 65 mm.

The resulting battery is hereinafter referred to as “battery A”.

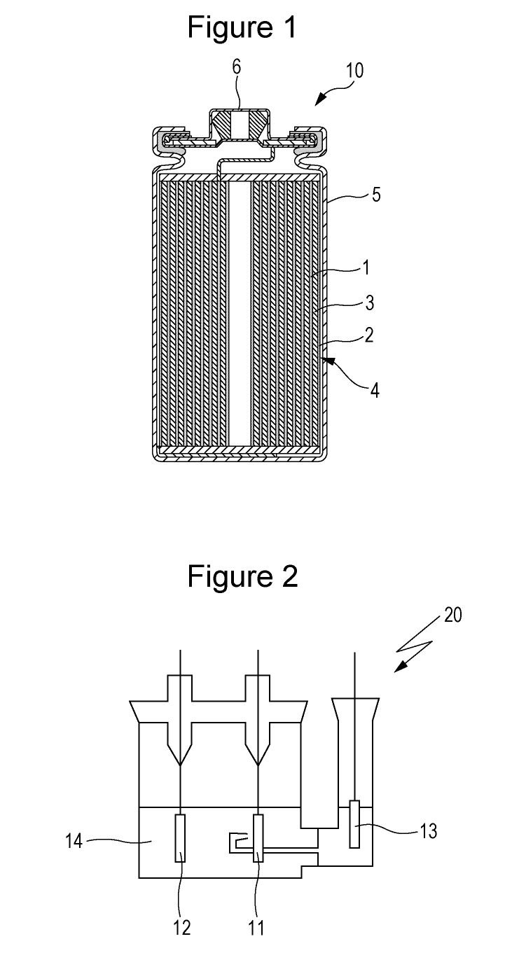

FIG. 1 is a schematic sectional view illustrating a nonaqueous electrolyte secondary battery produced as described above. As illustrated in FIG. 1, an electrode assembly 4 including a positive electrode 1, a negative electrode 2, and a separator 3 is arranged in a negative-electrode can 5. A sealing member 6 that also serves as a positive-electrode terminal is arranged above the negative-electrode can 5 and secured by crimping an upper portion of the negative-electrode can 5 to produce a nonaqueous electrolyte secondary battery 10.

### Comparative Example 1

A battery was produced as in Example described above, except that lithium difluorophosphate was not added when the nonaqueous electrolytic solution was prepared.

The resulting battery is hereinafter referred to as “battery Z1”.

### Comparative Example 2

A battery was produced as in Example described above, except that erbium oxyhydroxide was not adhered to the surface of lithium nickel cobalt manganese oxide.

The resulting battery is hereinafter referred to as “battery Z2”.

### Comparative Example 3

A battery was produced as in Example described above, except that erbium oxyhydroxide was not adhered to the surface of lithium nickel cobalt manganese oxide and that lithium difluorophosphate was not added when the nonaqueous electrolytic solution was prepared.

The resulting battery is hereinafter referred to as “battery Z3”.

### Comparative Example 4

A battery was produced as in Example described above, except that 0.5% by mole of zirconium element was adhered with respect to the total molar amount of the transition metals in lithium nickel cobalt manganese oxide and that erbium oxyhydroxide was not adhered to the surface of lithium nickel cobalt manganese oxide.

The resulting battery is hereinafter referred to as “battery Z4”.

### Comparative Example 5

A battery was produced as in Comparative example 4, except that lithium difluorophosphate was not added when the nonaqueous electrolytic solution was prepared.

The resulting battery is hereinafter referred to as “battery Z5”.

### (Experiment)

For batteries A and Z1 to Z5, 200 charge-discharge cycles were performed under conditions described below, and the capacity maintenance ratio represented by expression (1) was studied. Table 1 describes the results.

Charge-Discharge Conditions

At a temperature of 25° C., constant-current charge was performed at a charging current of 2.0 it (4.0 A) until the battery voltage reached 4.35 V. Then constant-voltage charge was performed at a battery voltage of 4.35 V until the current reached 0.02 It (0.04 A). Next, each battery was subjected to constant-current discharge to 2.5 V at a discharge current of 10.0 It (20.0 A).

Capacity maintenance ratio=(discharge capacity in 200th cycle/discharge capacity in first cycle)×100 (1)

TABLE 1

| | Presence or absence | Addition or non- | Presence or absence | |
|---|---|---|---|---|
| | of adherence of | addition of lithium | of adherence of | Capacity |
| | erbium oxyhydroxide | difluorophosphate | zirconium | maintenance |
| Battery | (amount adhered) | (amount added) | (amount adhered) | ratio (%) |
| A | present | added | absent | 86% |
| | (0.1 mol %) | (0.46 mol %) | | |
| Z1 | present | not added | absent | 79% |
| | (0.1 mol %) | | | |
| Z2 | absent | added | absent | 48% |
| | | (0.46 mol %) | | |
| Z3 | absent | not added | absent | 53% |
| Z4 | absent | added | present | 64% |
| | | (0.46 mol %) | (0.5 mol %) | |
| Z5 | absent | not added | present | 71% |
| | | | (0.5 mol %) | |

As is clear from Table 1, battery A has a high capacity maintenance ratio, compared with batteries Z1 to Z5. A comparison between batteries Z1 and Z3, in which lithium difluorophosphate is not added, reveals that battery Z1, in which erbium oxyhydroxide is adhered, has a high capacity maintenance ratio, compared with battery Z3, in which erbium oxyhydroxide is not adhered. A comparison between batteries Z2 and Z3, in which erbium oxyhydroxide is not adhered, reveals that battery Z2, in which lithium difluorophosphate is added, has a low capacity maintenance ratio, compared with battery Z3, in which lithium difluorophosphate is not added. A comparison between batteries Z4 and Z5, in which erbium oxyhydroxide is not adhered and zirconium is adhered, reveals that battery Z4, in which lithium difluorophosphate is added, has a low capacity maintenance ratio, compared with battery Z5, in which lithium difluorophosphate is not added.

The results demonstrate that the addition of lithium difluorophosphate (a lithium salt having a P—O bond and a P—F bond in its molecule) to the nonaqueous electrolytic solution reduces the capacity maintenance ratio. The reason for this is presumably that a sufficient film is not formed with lithium difluorophosphate alone in the large-current discharge cycle. Also in the case of using lithium nickel cobalt manganese oxide (lithium transition metal oxide) with the surface to which erbium oxyhydroxide (rare-earth element) is adhered, the capacity maintenance ratio is reduced. The reason for this is presumably that the adherence of the rare-earth element to the surface inhibits the decomposition reaction between lithium nickel cobalt manganese oxide and the electrolytic solution and that a good-quality film for the large-current discharge cycle is not formed. In contrast, in the case where lithium nickel cobalt manganese oxide with the surface to which erbium oxyhydroxide is adhered and lithium difluorophosphate are used together, the capacity maintenance ratio is specifically increased. Although the reason for this is unclear, it is speculated that erbium (rare-earth element) in erbium oxyhydroxide reacts with lithium difluorophosphate at the time of charging to form a good-quality film having both lithium-ion permeability and electrical conductivity on the surface of lithium nickel cobalt manganese oxide while the decomposition reaction of the nonaqueous electrolytic solution is inhibited.

### Second Example

### Example 1

A battery was produced as in Example of the first example, except that lithium difluorophosphate was added in a proportion of 0.01% by mole with respect to the total molar amount of the nonaqueous electrolyte when the nonaqueous electrolytic solution was prepared.

The resulting battery is hereinafter referred to as “battery B1”.

### Example 2

A battery was produced as in Example of the foregoing first example, except that lithium difluorophosphate was added in a proportion of 0.5% by mole with respect to the total molar amount of the nonaqueous electrolyte when the nonaqueous electrolytic solution was prepared.

The resulting battery is hereinafter referred to as “battery B2”.

### Example 3

A battery was produced as in Example of the first example, except that lithium difluorophosphate was added in a proportion of 1% by mole with respect to the total molar amount of the nonaqueous electrolyte when the nonaqueous electrolytic solution was prepared.

The resulting battery is hereinafter referred to as “battery B3”.

### Example 4

A battery was produced as in Example of the first example, except that lithium difluorophosphate was added in a proportion of 3% by mole with respect to the total molar amount of the nonaqueous electrolyte when the nonaqueous electrolytic solution was prepared.

The resulting battery is hereinafter referred to as “battery B4”.

### Comparative Example

A battery was produced as in Example of the first example, except that lithium difluorophosphate was not added when the nonaqueous electrolytic solution was prepared.

The resulting battery is hereinafter referred to as “battery Y”.

### (Experiment)

For batteries B1 to B4 and Y, 150 charge-discharge cycles were performed under conditions described below, and the capacity maintenance ratio represented by expression (2) was studied. Furthermore, a voltage 1 second after discharge initiation in the 150th cycle was measured. Table 2 describes the results.

Charge-Discharge Conditions

At a temperature of 25° C., constant-current charge was performed at a charging current of 2.0 it (4.0 A) until the battery voltage reached 4.35 V. Then constant-voltage charge was performed at a battery voltage of 4.35 V until the current reached 0.02 It (0.04 A). Next, each battery was subjected to constant-current discharge to 2.5 V at a discharge current of 10.0 It (20.0 A).

Capacity maintenance ratio=(discharge capacity in 150th cycle/discharge capacity in first cycle)×100 (2)

TABLE 2

| | Presence or absence | | | | |
|---|---|---|---|---|---|
| | of adherence of | Amount of lithium | | Voltage 1 second after | Capacity |
| | erbium oxyhydroxide | difluorophosphate | | discharge initiation in | maintenance |
| Battery | (amount adhered) | added (mol %) | | 150th cycle (V) | ratio (%) |
| B1 | present | 0.01 | mol % | 3.696 V | 87.8% |
| | (0.1 mol %) | | | | |
| B2 | | 0.5 | mol % | 3.704 V | 88.5% |
| B3 | | 1 | mol % | 3.758 V | 88.9% |
| B4 | | 3 | mol % | 3.744 V | 87.5% |

| | | | |
|---|---|---|---|
| Y | — | 3.476 V | 82.7% |

As is clear from Table 2, in batteries B1 to B4, in which lithium difluorophosphate is added, a reduction in voltage 1 second after discharge initiation in the 150th cycle is inhibited, and the capacity maintenance ratio is high, compared with battery Y, in which lithium difluorophosphate is not added.

These results demonstrate that in the case where erbium oxyhydroxide (compound of the rare-earth element) is adhered to the surface of lithium nickel cobalt manganese oxide (lithium transition metal oxide) and where the amount of lithium difluorophosphate (a lithium salt having a P—O bond and a P—F bond in its molecule) is 0.01% by mole or more and 3% by mole or less with respect to the total molar amount of the nonaqueous electrolyte, erbium (rare-earth element) in erbium oxyhydroxide reacts with lithium difluorophosphate at the time of charging to assuredly form the good-quality film having both lithium-ion permeability and electrical conductivity on the surface of lithium nickel cobalt manganese oxide. This presumably inhibits the decomposition reaction of the nonaqueous electrolytic solution when the large-current discharge cycle is repeated, and inhibits the reduction in voltage immediately after discharge initiation, thereby providing a high capacity maintenance ratio even when the large-current discharge cycle is repeated.

### Third Example

### Example 1

A battery was produced as in Example of the first example, except that lithium difluorophosphate was added in a proportion of 0.5% by mole with respect to the total molar amount of the nonaqueous electrolyte when the nonaqueous electrolytic solution was prepared.

The resulting battery is hereinafter referred to as “battery C1”.

### Example 2

A battery was produced as in Example 1 of the foregoing third example, except that lithium difluoro(oxalato)borate (Li[B(C₂O₄)F₂]: LiFOB) was used in place of lithium difluorophosphate when the nonaqueous electrolytic solution was prepared.

The resulting battery is hereinafter referred to as “battery C2”.

### Comparative Example 1

A battery was produced as in Example 1 of the third example, except that lithium phosphate (Li₃PO₄) was used in place of lithium difluorophosphate when the nonaqueous electrolytic solution was prepared.

The resulting battery is hereinafter referred to as “battery X1”.

### Comparative Example 2

A battery was produced as in Example 1 of the third example, except that lithium hexafluorophosphate (LiPF₆) was used in place of lithium difluorophosphate when the nonaqueous electrolytic solution was prepared.

The resulting battery is hereinafter referred to as “battery X2”.

### Comparative Example 3

A battery was produced as in Example 1 of the third example, except that lithium bis(oxalato)borate (Li[B(C₂O₄)₂]: LiBOB) was used in place of lithium difluorophosphate when the nonaqueous electrolytic solution was prepared.

The resulting battery is hereinafter referred to as “battery X3”.

### Comparative Example 4

A battery was produced as in Example 1 of the third example, except that lithium tetrafluoroborate (LiBF₄) was used in place of lithium difluorophosphate when the nonaqueous electrolytic solution was prepared.

The resulting battery is hereinafter referred to as “battery X4”.

### (Experiment)

For batteries C1 to C2 and X1 to X4, 100 charge-discharge cycles were performed under conditions described below, and a voltage 1 second after discharge initiation in the 100th cycle was measured. Table 3 describes the results.

Charge-Discharge Conditions

At a temperature of 25° C., constant-current charge was performed at a charging current of 2.0 it (4.0 A) until the battery voltage reached 4.35 V. Then constant-voltage charge was performed at a battery voltage of 4.35 V until the current reached 0.02 It (0.04 A). Next, each battery was subjected to constant-current discharge to 2.5 V at a discharge current of 10.0 It (20.0 A).

TABLE 3

| | Presence or absence | | Amount of | Voltage 1 second |
|---|---|---|---|---|
| | of adherence of | | lithium salt | after discharge |
| | erbium oxyhydroxide | | as additive | initiation in 100th |
| Battery | (amount adhered) | Lithium salt as additive | added | cycle (V) |
| C1 | present | lithium difluorophosphate | 0.5 mol % | 3.730 V |
| | (0.1 mol %) | (LiPO₂F₂) | | |
| C2 | | lithium difluoro(oxalato)borate | | 3.707 V |
| | | (Li[B(C₂O₄)F₂]) | | |
| X1 | | lithium phosphate | | 3.621 V |
| | | (Li₃PO₄) | | |
| X2 | | lithium hexafluorophosphate | | 3.667 V |
| | | (LiPF₆) | | |
| X3 | | lithium bis(oxalato)borate | | 3.689 V |
| | | (Li[B(C₂O₄)₂]) | | |
| X4 | | lithium tetrafluoroborate | | 3.621 V |
| | | (LiBF₄) | | |

It is clear from the results that in battery C1, in which lithium difluorophosphate (a lithium salt having a P—O bond and a P—F bond in its molecule) is added to the nonaqueous electrolytic solution, and battery C2, in which lithium difluoro(oxalato)borate (a lithium salt having a B—O bond and a B—F bond in its molecule) is added, a reduction in voltage 1 second after discharge initiation in the 100th cycle is lowered, compared with battery X1, in which lithium phosphate (a lithium salt having a P—O bond alone in its molecule) is added to the nonaqueous electrolytic solution, battery X2, in which lithium hexafluorophosphate (a lithium salt having a P—F bond alone in its molecule) is added, battery X3, in which lithium bis(oxalato)borate (a lithium salt having a B—O bond alone in its molecule), and battery X4, in which lithium tetrafluoroborate (a lithium salt having a B—F bond alone in its molecule) is added. Thus, the results reveal that batteries C1 and C2 have improved cycle characteristics.

These results demonstrate that in the case where erbium oxyhydroxide (compound of the rare-earth element) is adhered to the surface of lithium nickel cobalt manganese oxide (lithium transition metal oxide) and where lithium difluorophosphate (a lithium salt having a P—O bond and a P—F bond in its molecule) and lithium difluoro(oxalato)borate (a lithium salt having a B—O bond and a B—F bond in its molecule) are present in the nonaqueous electrolytic solution, the reduction in voltage immediately after the initiation of large-current discharge is inhibited, compared with the cases where the lithium salt having a P—O bond in its molecule, the lithium salt having a P—F bond in its molecule, the lithium salt having a B—O bond in its molecule, and the lithium salt having a B—F bond in its molecule are separately present in the respective nonaqueous electrolytic solutions. Although the reason for this is unclear, it is speculated that erbium (rare-earth element) in erbium oxyhydroxide reacts with lithium difluorophosphate and lithium difluoro(oxalato)borate at the time of charging to form a good-quality film having both lithium-ion permeability and electrical conductivity on the surface of lithium nickel cobalt manganese oxide while the decomposition reaction of the nonaqueous electrolytic solution is inhibited.

Although the reason the reduction in voltage immediately after the initiation of large-current discharge is not inhibited even if the lithium salt having a P—O bond in its molecule, the lithium salt having a P—F bond in its molecule, the lithium salt having a B—O bond in its molecule, and the lithium salt having a B—F bond in its molecule are separately present in the respective nonaqueous electrolytic solutions is unclear, it is speculated that the foregoing good-quality film is not formed even if the rare-earth element reacts with the lithium salt having a P—O bond in its molecule, the lithium salt having a P—F bond in its molecule, the lithium salt having a B—O bond in its molecule, and the lithium salt having a B—F bond in its molecule added in the nonaqueous electrolytic solutions at the time of charging.

### Fourth Example

### Example 1

### Synthesis of Positive Electrode Active Material

A positive electrode active material was synthesized in the same way as in Example of the first example.

### [Production of Positive Electrode for Three-Electrode Test Cell]

With 100 parts by mass of the positive electrode active material, 5 parts by mass of carbon black serving as a carbon conductive agent and 3 parts by mass of polyvinylidene fluoride serving as a binder were mixed. An appropriate amount of N-methyl-2-pyrrolidone (NNP) was added thereto, thereby preparing a positive-electrode slurry. The positive-electrode slurry was applied to both surfaces of a positive-electrode collector composed of aluminum, dried, and cut to give a piece with a predetermined electrode size. The piece was rolled with rollers and fitted with a positive-electrode lead to provide a positive electrode for a three-electrode test cell.

### [Production of Three-Electrode Test Cell]

As illustrated in FIG. 2, the positive electrode was used as a working electrode 11. A counter electrode 12 serving as a negative electrode and a reference electrode 13 were each composed of metallic lithium. A three-electrode test cell 20 was produced with a nonaqueous electrolytic solution 14 prepared as follows: LiPF₆ serving as a solute was dissolved in a solvent mixture in a concentration of 1.0 mol/L, the solvent mixture containing ethylene carbonate, methyl ethyl carbonate, and dimethyl carbonate mixed in a volume ratio of 3:3:4. Then 1% by mass of vinylene carbonate was added to the resulting solution. Furthermore, lithium difluorophosphate was added thereto in a proportion of 0.4% by mole with respect to the total molar amount of the nonaqueous electrolyte.

The resulting cell is hereinafter referred to as “cell D1”.

### Comparative Example 1

A cell was produced as in Example 1 of the foregoing fourth example, except that lithium difluorophosphate was not added to the nonaqueous electrolytic solution.

The resulting cell is hereinafter referred to as “cell W1”.

### Example 2

A cell was produced as in Example 1 of the fourth example, except that 4.47 g of lanthanum nitrate hexahydrate was used in place of erbium nitrate pentahydrate (lithium nickel cobalt manganese oxide with a surface to which lanthanum oxyhydroxide was uniformly adhered was prepared) when the positive electrode active material was prepared.

The resulting cell is hereinafter referred to as “cell D2”.

### Comparative Example 2

A cell was produced as in Example 2 of the fourth example, except that lithium difluorophosphate was not added to the nonaqueous electrolytic solution.

The resulting cell is hereinafter referred to as “cell W2”.

### Example 3

A cell was produced as in Example 1 of the fourth example, except that 4.53 g of neodymium nitrate hexahydrate was used in place of erbium nitrate pentahydrate (lithium nickel cobalt manganese oxide with a surface to which neodymium oxyhydroxide was uniformly adhered was prepared) when the positive electrode active material was prepared.

The resulting cell is hereinafter referred to as “cell D3”.

### Comparative Example 3

A cell was produced as in Example 3 of the fourth example, except that lithium difluorophosphate was not added to the nonaqueous electrolytic solution.

The resulting cell is hereinafter referred to as “cell W3”.

### Example 4

A cell was produced as in Example 1 of the fourth example, except that 4.59 g of samarium nitrate hexahydrate was used in place of erbium nitrate pentahydrate (lithium nickel cobalt manganese oxide with a surface to which samarium oxyhydroxide was uniformly adhered was prepared) when the positive electrode active material was prepared.

The resulting cell is hereinafter referred to as “cell D4”.

### Comparative Example 4

A cell was produced as in Example 4 of the fourth example, except that lithium difluorophosphate was not added to the nonaqueous electrolytic solution.

The resulting cell is hereinafter referred to as “cell W4”.

### Comparative Example 5

A cell was produced as in Example of the fourth example, except that an oxyhydroxide was not adhered to the surface of lithium nickel cobalt manganese oxide.

The resulting cell is hereinafter referred to as “cell W5”

### Comparative Example 6

A cell was produced as in Comparative example 5 of the fourth example, except that lithium difluorophosphate was not added to the nonaqueous electrolytic solution.

The resulting cell is hereinafter referred to as “cell W6”.

### (Experiment)

For cells D1 to D4 and W1 to W6, 10 charge-discharge cycles were performed under conditions described below, and the capacity maintenance ratio represented by expression (3) was studied. Table 4 describes the results.

Charge-Discharge Conditions

At a temperature of 25° C., for each of cells D1 to D4 and W1 to W6, constant-current charge was performed at a current density of 8 mA/cm² (2.0 It) to 4.5 V (vs. Li/Li⁺). Then constant-voltage charge was performed at a constant voltage of 4.5 V (vs. Li/Li⁺) until the current density reached 0.08 mA/cm² (0.02 It). Next, each cell was subjected to constant-current discharge to 2.5 V (vs. Li/Li⁺) at a current density of 8 mA/cm² (2.0 It).

Capacity maintenance ratio=(discharge capacity in 10th cycle/discharge capacity in first cycle)×100 (3)

TABLE 4

| | | Rare-earth element | Amount of lithium | Capacity |
|---|---|---|---|---|
| | Positive electrode | of oxyhydroxide | difluorophosphate | maintenance |
| Battery | active material | (amount adhered) | added (mol %) | ratio (%) |
| D1 | LiNi_{0.35}Co_{0.35}Mn_{0.30}O₂ | erbium (Er) | 0.4 mol % | 82.9% |
| W1 | | (0.1 mol %) | — | 79.3% |
| D2 | | lanthanum (La) | 0.4 mol % | 81.8% |
| W2 | | (0.1 mol %) | — | 77.9% |
| D3 | | neodymium (Nd) | 0.4 mol % | 82.3% |
| W3 | | (0.1 mol %) | — | 75.2% |
| D4 | | samarium (Sm) | 0.4 mol % | 82.8% |
| W4 | | (0.1 mol %) | — | 80.6% |
| W5 | | absent | 0.4 mol % | 73.7% |
| W6 | | | — | 75.3% |

As is clear from Table 4, each of cells D1 to D4 has a high capacity maintenance ratio, compared with cells W1 to W6. A comparison between cells W1 to W4, in which lithium difluorophosphate is not added, and cell W6 reveals that cell W1, in which erbium oxyhydroxide is adhered, cell W2, in which lanthanum oxyhydroxide is adhered, cell W3, in which neodymium oxyhydroxide is adhered, and cell W4, in which samarium oxyhydroxide is adhered, each have a capacity maintenance ratio substantially equal to or higher than that of cell W6, in which an oxyhydroxide is not adhered. A comparison between cells W5 and W6, in which an oxyhydroxide is not adhered, reveals that cell W5, in which lithium difluorophosphate is added, has a low capacity maintenance ratio, compared with cell W6, in which lithium difluorophosphate is not added.

The results demonstrate that the addition of lithium difluorophosphate (a lithium salt having a P—O bond and a P—F bond in its molecule) to the nonaqueous electrolytic solution reduces the capacity maintenance ratio. In contrast, in the case where the oxyhydroxide (compound of the rare-earth element) is adhered to the surface of lithium nickel cobalt manganese oxide (lithium transition metal oxide), the capacity maintenance ratio is specifically increased. Although the reason for this is unclear, it is speculated that the rare-earth element in the oxyhydroxide reacts with lithium difluorophosphate at the time of charging to form a good-quality film having both lithium-ion permeability and electrical conductivity while the decomposition reaction of the nonaqueous electrolytic solution is inhibited.

In each of cells W1 to W6, lithium difluorophosphate is not added to the nonaqueous electrolytic solution. It is thus speculated that such a good-quality film having both lithium-ion permeability and electrical conductivity is less likely to be formed on the surface of lithium nickel cobalt manganese oxide, thereby failing to provide the effect of improving the capacity maintenance ratio.

In this example, erbium, lanthanum, neodymium, and samarium were used as the rare-earth elements in the oxyhydroxides of the rare-earth elements (compounds of the rare-earth elements). The good-quality film having both lithium-ion permeability and electrical conductivity is seemingly formed by the reaction of the rare-earth element with lithium difluorophosphate (a lithium salt having a P—O bond and a P—F bond in its molecule) at the time of charging. Thus, the same effect is seemingly provided even when another rare-earth element is used.

Cells D1, D3, and D4, in which the compound of erbium, neodymium, or samarium is adhered to the surface of lithium nickel cobalt manganese oxide, have improved capacity maintenance ratios, compared with cell D2, in which the lanthanum compound is adhered to the surface of lithium nickel cobalt manganese oxide. Thus, as the rare-earth element in the compound of the rare-earth element adhered to the surface of lithium nickel cobalt manganese oxide (lithium-containing metal oxide), erbium, lanthanum, neodymium, and samarium are preferably used. Of these, erbium, neodymium, and samarium are preferably used.

### Fifth Example

### Example 1

### Synthesis of Positive Electrode Active Material

A positive electrode active material was synthesized in the same way as in Example of the first example.

### [Production of Positive Electrode]

With 100 parts by mass of the positive electrode active material, 5 parts by mass of carbon black serving as a carbon conductive agent and 3 parts by mass of polyvinylidene fluoride serving as a binder were mixed. An appropriate amount of N-methyl-2-pyrrolidone (NMP) was added thereto, thereby preparing a positive-electrode slurry. The positive-electrode slurry was applied to both surfaces of a positive-electrode collector composed of aluminum, dried, and cut to give a piece with a predetermined electrode size. The piece was rolled with rollers and fitted with a positive-electrode lead to provide a monopolar cell (positive electrode).

### [Production of Negative Electrode]

First, 98 parts by mass of artificial graphite serving as a negative electrode active material, 1 part by mass of carboxymethylcellulose serving as a thickener, and 1 part by mass of styrene-butadiene rubber serving as a binder were mixed together. An appropriate amount of deionized water was added thereto, thereby preparing a negative-electrode slurry. The negative-electrode slurry was applied to both surfaces of a negative-electrode collector formed of copper foil, dried, and cut to give a piece with a predetermined electrode size. The piece was rolled with rollers and fitted with a negative-electrode lead to provide a negative electrode.

### [Preparation of Nonaqueous Electrolyte]

LiPF₆ serving as a solute was dissolved in a solvent mixture in a proportion of 1.0 mol/L, the solvent mixture containing ethylene carbonate (EC), methyl ethyl carbonate (MEC), and dimethyl carbonate (DMC) mixed in a volume ratio of 3:3:4. Then 1% by mass of vinylene carbonate was added to the resulting solution. Furthermore, lithium difluorophosphate was added thereto in a proportion of 0.4% by mole with respect to the total molar amount of the nonaqueous electrolyte, thereby preparing a nonaqueous electrolytic solution.

### [Production of Battery]

A battery (capacity: 1.4 Ah) was produced in the same way as in Example of the first example.

The resulting battery is hereinafter referred to as “battery E1”.

### Example 2

A battery was produced as in Example 1 of the foregoing fifth example, except that the amount of erbium oxyhydroxide adhered to the surface of lithium nickel cobalt manganese oxide was 0.08% by mole.

The resulting battery is hereinafter referred to as “battery E2”.

### Example 3

A battery was produced as in Example 1 of the fifth example, except that the amount of erbium oxyhydroxide adhered to the surface of lithium nickel cobalt manganese oxide was 0.04% by mole.

The resulting battery is hereinafter referred to as “battery E3”.

### Comparative Example

A battery was produced as in Example 1 of the fifth example, except that erbium oxyhydroxide was not adhered to the surface of lithium nickel cobalt manganese oxide.

The resulting battery is hereinafter referred to as “battery V”.

### (Experiment)

For batteries E1 to E3 and V, 300 charge-discharge cycles were performed under conditions described below, and the capacity maintenance ratio represented by expression (4) was studied. Table 5 describes the results.

Charge-Discharge Conditions

At a temperature of 25° C., constant-current charge was performed at a charging current of 2.0 It (2.8 A) until the battery voltage reached 4.3 V. Then constant-voltage charge was performed at a battery voltage of 4.3 V until the current reached 0.02 It (0.028 A). Next, each battery was subjected to constant-current discharge to 2.5 V at a discharge current of 2.0 It (2.8 A).

Capacity maintenance ratio=(discharge capacity in 300th cycle/discharge capacity in first cycle)×100 (4)

TABLE 5

| | | Amount of erbium | | Amount of lithium | Capacity |
|---|---|---|---|---|---|
| | Positive electrode | oxyhydroxide | | difluorophosphate | maintenance |
| Battery | active material | adhered (mol %) | | added (mol %) | ratio (%) |
| E1 | LiNi_{0.35}Co_{0.35}Mn_{0.30}O₂ | 0.1 | mol % | 0.4 mol % | 94% |
| E2 | | 0.08 | mol % | | 96% |
| E3 | | 0.04 | mol % | | 95% |

| | | |
|---|---|---|
| V | zero | 91% |

As is clear from Table 5, in the case where lithium difluorophosphate is added to the nonaqueous electrolytic solution, batteries E1 to E3, in which erbium oxyhydroxide is adhered, have high capacity maintenance ratios after the large-current discharge cycles, compared with battery V, in which erbium oxyhydroxide is not adhered.

These results demonstrate that in the case where lithium difluorophosphate is added to the nonaqueous electrolytic solution and where the amount of erbium oxyhydroxide (compound of the rare-earth element) adhered to the surface of lithium nickel cobalt manganese oxide (lithium transition metal oxide) is 0.04% by mole or more and 0.1% by mole or less, erbium (rare-earth element) in erbium oxyhydroxide reacts with lithium difluorophosphate at the time of charging to assuredly form the good-quality film having both lithium-ion permeability and electrical conductivity on the surface of lithium nickel cobalt manganese oxide. This presumably inhibits the decomposition reaction of the nonaqueous electrolytic solution when the large-current discharge cycle is repeated, thereby providing a high capacity maintenance ratio even when the large-current discharge cycle is repeated.

### Sixth Example

### Example 1

A positive electrode active material was synthesized in the same way as in Example of the first example, except that particles of lithium nickel cobalt aluminum oxide represented by LiNi_{0.80}CO_{0.15}Al_{0.05}O₂ was used in place of the lithium nickel cobalt manganese oxide particles. Thereby lithium nickel cobalt aluminum oxide with a surface to which erbium oxyhydroxide was uniformly adhered was provided. The amount of erbium oxyhydroxide adhered was, in terms of elemental erbium, 0.1% by mole with respect to the total molar amount of transition metals in lithium nickel cobalt aluminum oxide.

### [Production of Positive Electrode for Three-Electrode Test Cell]

With 100 parts by mass of the positive electrode active material, 4 parts by mass of carbon black serving as a carbon conductive agent and 2 parts by mass of polyvinylidene fluoride serving as a binder were mixed. An appropriate amount of N-methyl-2-pyrrolidone (NMP) was added thereto, thereby preparing a positive-electrode slurry. The positive-electrode slurry was applied to both surfaces of a positive-electrode collector composed of aluminum, dried, and cut to give a piece with a predetermined electrode size. The piece was rolled with rollers and fitted with a positive-electrode lead to provide a positive electrode for a three-electrode test cell.

### [Production of Three-Electrode Test Cell]

As illustrated in FIG. 2, the positive electrode was used as the working electrode 11. The counter electrode 12 serving as a negative electrode and the reference electrode 13 were each composed of metallic lithium. The three-electrode test cell 20 was produced with the nonaqueous electrolytic solution 14 prepared as follows: LiPF₆ serving as a solute was dissolved in a solvent mixture in a concentration of 1.0 mol/L, the solvent mixture containing ethylene carbonate, methyl ethyl carbonate, and dimethyl carbonate mixed in a volume ratio of 3:3:4. Then 1% by mass of vinylene carbonate was added to the resulting solution. Furthermore, lithium difluorophosphate was added thereto in a proportion of 0.4% by mole with respect to the total molar amount of the nonaqueous electrolyte.

The resulting cell is hereinafter referred to as “cell F1”.

### Comparative Example 1

A cell was produced as in Example 1 of the foregoing sixth example, except that lithium difluorophosphate was not added when the nonaqueous electrolytic solution was prepared.

The resulting cell is hereinafter referred to as “cell U1”.

### Comparative Example 2

A cell was produced as in Example 1 of the sixth example, except that erbium oxyhydroxide was not adhered to the surface of lithium nickel cobalt aluminum oxide.

The resulting cell is hereinafter referred to as “cell U2”.

### Comparative Example 3

A cell was produced as in Example 1 of the sixth example, except that erbium oxyhydroxide was not adhered to the surface of lithium nickel cobalt aluminum oxide and that lithium difluorophosphate was not added when the nonaqueous electrolytic solution was prepared.

The resulting cell is hereinafter referred to as “cell U3”.

### Example 2

A cell was produced as in Example 1 of the sixth example, except that lithium cobaltate represented by LiCoO₂ was used in place of the lithium nickel cobalt aluminum oxide particles and that lithium cobaltate with a surface to which erbium oxyhydroxide was uniformly adhered was provided. The amount of erbium oxyhydroxide adhered was, in terms of elemental erbium, 0.1% by mole with respect to the total molar amount of the transition metal in lithium cobaltate.

The resulting cell is hereinafter referred to as “cell F2”.

### Comparative Example 4

A cell was produced as in Example 2 of the sixth example, except that lithium difluorophosphate was not added when the nonaqueous electrolytic solution was prepared.

The resulting cell is hereinafter referred to as “cell U4”.

### Comparative Example 5

A cell was produced as in Example 2 of the sixth example, except that erbium oxyhydroxide was not adhered to the surface of lithium nickel cobalt manganese oxide.

The resulting cell is hereinafter referred to as “cell U5”.

### Comparative Example 6

A cell was produced as in Example 2 of the sixth example, except that erbium oxyhydroxide was not adhered to the surface of lithium nickel cobalt manganese oxide and that lithium difluorophosphate was not added when the nonaqueous electrolytic solution was prepared.

The resulting cell is hereinafter referred to as “cell U6”.

### (Experiment)

For cells F1, F2, and U1 to U6, 40 charge-discharge cycles were performed under conditions described below, and the capacity maintenance ratio represented by expression (5) was studied. Table 6 describes the results.

Charge-Discharge Conditions

At a temperature of 25° C., for each of cells F1, F2, and U1 to U6, constant-current charge was performed at a current density of 4 mA/cm² (2.0 It) to 4.5 V (vs. Li/Li⁺). Then constant-voltage charge was performed at a constant voltage of 4.5 V (vs. Li/Li⁺) until the current density reached 0.04 mA/cm² (0.02 It). Next, each cell was subjected to constant-current discharge to 2.5 V (vs. Li/Li⁺) at a current density of 4 mA/cm² (2.0 It).

Capacity maintenance ratio=(discharge capacity in 40th cycle/discharge capacity in first cycle)×100 (5)

TABLE 6

| | | Presence or absence | | |
|---|---|---|---|---|
| | | of adherence of | Amount of lithium | Capacity |
| | Positive electrode | erbium oxyhydroxide | difluorophosphate | maintenance |
| Battery | active material | (amount adhered) | added (mol %) | ratio (%) |
| F1 | LiNi_{0.80}Co_{0.15}Al_{0.05}O₂ | present | 0.5 mol % | 85.9% |
| U1 | | (0.1 mol %) | — | 83.2% |
| U2 | | absent | 0.5 mol % | 81.2% |
| U3 | | | — | 81.3% |
| F2 | LiCoO₂ | present | 0.5 mol % | 93.7% |
| U4 | | (0.1 mol %) | — | 93.0% |
| U5 | | absent | 0.5 mol % | 16.8% |
| U6 | | | — | 8.1% |

As is clear from Table 6, in the case where LiNi_{0.80}CO_{0.15}Al_{0.05}O₂ was used as a positive electrode active material, cell F1 has a high capacity maintenance ratio, compared with cells U1 to U3. A comparison between cells U1 and U3, in which lithium difluorophosphate is not added, reveals that cell U1, in which erbium oxyhydroxide is adhered, has a high capacity maintenance ratio, compared with cell U3, in which erbium oxyhydroxide is not adhered.

A comparison between cells U2 and U3, in which erbium oxyhydroxide is not adhered, reveals that cell U2, in which lithium difluorophosphate is added, has a low capacity maintenance ratio, compared with cell U3, in which lithium difluorophosphate is not added.

In conclusion, the addition of lithium difluorophosphate (a lithium salt having a P—O bond and a P—F bond in its molecule) to the nonaqueous electrolytic solution reduces the capacity maintenance ratio. In the case where erbium oxyhydroxide (compound of the rare-earth element) is adhered to the surface of lithium nickel cobalt aluminum oxide (lithium transition metal oxide), the capacity maintenance ratio is increased, similarly to the case where lithium nickel cobalt manganese oxide is used as a positive electrode active material. Although the reason for this is unclear, it is speculated that the rare-earth element in the oxyhydroxide reacts with lithium difluorophosphate at the time of charging to form a good-quality film having both lithium-ion permeability and electrical conductivity while the decomposition reaction of the nonaqueous electrolytic solution.

As is clear from Table 6, in the case where LiCoO₂ is used as a positive electrode active material, cell F2 has a high capacity maintenance ratio, compared with cells U3 to U6.

These results demonstrate that in the case where erbium oxyhydroxide (compound of the rare-earth element) is adhered to the surface of lithium cobaltate (lithium transition metal oxide), the addition of lithium difluorophosphate (a lithium salt having a P—O bond and a P—F bond in its molecule) to the nonaqueous electrolytic solution increases the capacity maintenance ratio, compared with the case where lithium difluorophosphate (a lithium salt having a P—O bond and a P—F bond in its molecule) is not added to the nonaqueous electrolytic solution.

### Seventh Example

### Example 1

A three-electrode test cell was produced in the same way as in Example 1 of the fourth example.

The resulting cell is hereinafter referred to as “cell G1”.

### Example 2

A three-electrode test cell was produced as in Example 1 of the foregoing seventh example, except that the heat-treatment temperature at which the positive electrode active material was synthesized was 150° C. and that lithium nickel cobalt manganese oxide with a surface to which erbium hydroxide was uniformly adhered was provided.

The resulting cell is hereinafter referred to as “cell G2”.

### Example 3

A three-electrode test cell was produced as in Example 1 of the seventh example, except that the heat-treatment temperature at which the positive electrode active material was synthesized was 600° C. and that lithium nickel cobalt manganese oxide with a surface to which erbium oxide was uniformly adhered was provided.

The resulting cell is hereinafter referred to as “cell G3”.

### Comparative Example

A three-electrode test cell was produced as in Example 1 of the seventh example, except that an erbium compound was not adhered to the surface of lithium nickel cobalt manganese oxide.

The resulting cell is hereinafter referred to as “cell T1”.

### (Experiment)

The capacity maintenance ratios of cells G1 to G3, T1, and W were studied in the same way as in the fourth example. Table 7 describes the results.

TABLE 7

| | | | Amount of lithium | Capacity |
|---|---|---|---|---|
| | Positive electrode | Erbium compound | difluorophosphate | maintenance |
| Battery | active material | (amount adhered) | added (mol %) | ratio (%) |
| G1 | LiNi_{0.35}Co_{0.35}Mn_{0.30}O₂ | Erbium oxyhydroxide | 0.4 mol % | 82.9% |
| | | (0.1 mol %) | | |
| G2 | | Erbium hydroxide | | 81.8% |
| | | (0.1 mol %) | | |
| G3 | | Erbium oxide | | 80.5% |
| | | (0.1 mol %) | | |
| T1 | | not used | | 79.3% |

As is clear from Table 7, each of cells G1 to G3 has a high capacity maintenance ratio, compared with cell T1.

The results demonstrate that in the case where erbium oxyhydroxide (an oxyhydroxide of the rare-earth element), erbium hydroxide (hydroxide of the rare-earth element), and erbium oxide (oxide of the rare-earth element) were used as an erbium compound (compound of the rare-earth element) adhered to the surface of lithium nickel cobalt manganese oxide (lithium transition metal oxide), the rare-earth element in the compound of the rare-earth element adhered to the surface of lithium nickel cobalt manganese oxide reacts with lithium difluorophosphate at the time of charging to assuredly form the good-quality film having both lithium-ion permeability and electrical conductivity on the surface of lithium nickel cobalt manganese oxide.

### INDUSTRIAL APPLICABILITY

An embodiment of the present invention is applicable to, for example, driving power sources for mobile information terminals, such as cellular phones, notebook personal computers, and smartphones, high-output driving power sources for electric vehicles, HEVs, electric power tools, and so forth, and power sources in relation to storage batteries.

### REFERENCE SIGNS LIST

1 positive electrode
2 negative electrode
3 separator
4 electrode assembly
5 negative-electrode can
6 sealing member
10 nonaqueous electrolyte secondary battery
20 three-electrode test cell
11 working electrode
12 counter electrode (metallic lithium)
13 reference electrode (metallic lithium)
14 nonaqueous electrolytic solution

1. A nonaqueous electrolyte secondary battery comprising:
a positive electrode containing a positive electrode active material that contains a lithium transition metal oxide having a surface to which a compound of a rare-earth element is adhered;
a negative electrode containing a negative electrode active material; and
a nonaqueous electrolyte to which a lithium salt having a P—O bond and a P—F bond in its molecule and/or a lithium salt having a B—O bond and a B—F bond in its molecule is added.

2. The nonaqueous electrolyte secondary battery according to claim 1, wherein the compound of the rare-earth element is a hydroxide of the rare-earth element, an oxyhydroxide of the rare-earth element, or an oxide of the rare-earth element.

3. The nonaqueous electrolyte secondary battery according to claim 1, wherein the rare-earth element in the compound of the rare-earth element is neodymium, samarium, or erbium.

4. The nonaqueous electrolyte secondary battery according to claim 1, wherein the lithium salt having a P—O bond and a P—F bond in its molecule and/or the lithium salt having a B—O bond and a B—F bond in its molecule is represented by the composition formula LiₓM_{y}O_{z}F_{α}C_{β}(wherein M represents B or P, x represents an integer of 1 to 4, y represents 1 or 2, z represents an integer of 1 to 8, α represents an integer of 1 to 4, and β represents an integer of 0 to 4).

5. The nonaqueous electrolyte secondary battery according to claim 1, wherein the proportion of the lithium salt having a P—O bond and a P—F bond in its molecule and/or the lithium salt having a B—O bond and a B—F bond in its molecule is 0.01% by mole or more and 5% by mole or less with respect to the total molar amount of the nonaqueous electrolyte.

6. The nonaqueous electrolyte secondary battery according to claim 5, wherein the proportion of the lithium salt having a P—O bond and a P—F bond in its molecule and/or the lithium salt having a B—O bond and a B—F bond in its molecule is 0.03% by mole or more and 2% by mole or less with respect to the total molar amount of the nonaqueous electrolyte.

7. The nonaqueous electrolyte secondary battery according to claim 1, wherein the lithium salt having a P—O bond and a P—F bond in its molecule is lithium monofluorophosphate or lithium difluorophosphate.

8. The nonaqueous electrolyte secondary battery according to claim 1, wherein the lithium transition metal oxide has a layered structure represented by the general formula LiMeO₂ (wherein Me represents at least one selected from the group consisting of Ni, Co, Mn, and Al).
